(19) United States
(12) Patent Application Publication
(10) Pub. No.: US 2026/0299382 A1
(43) Pub. Date: Oct. 1, 2026

(54) LIQUID CRYSTAL PROJECTOR

(71) Applicant: Sharp Display Technology Corporation, Kameyama City (JP)

(72) Inventors: Masahiro HASEGAWA, Kameyama City (JP); Takashi SATOH, Kameyama City (JP); Akira SAKAI, Kameyama City (JP); Kiyoshi MINOURA, Kameyama City (JP)

(21) Appl. No.: 19/632,711

(22) Filed: Mar. 30, 2026

(30) Foreign Application Priority Data
Apr. 1, 2025 (JP) 2025-060594

(51) Int. Cl. G03B 21/00; G02B 27/28; G02F 1/1337; G03B 21/20

(52) U.S. Cl. CPC G03B 21/006; G02B 27/283; G02F 1/133738; G03B 21/2073

(57) ABSTRACT

A liquid crystal projector includes a light source, a polarizing beam splitter, and first and second reflective liquid crystal panels each having a color filter and a plurality of pixels. Each pixel includes a plurality of subpixels. When two subpixels corresponding to an identical subpixel in a projected image is referred to as a subpixel set, a plurality of types of subpixel sets that are different in combination of colors of the two subpixels are present. When a subpixel set in which a sum of luminance index values of the colors of the two subpixels is largest is referred to as a first-class subpixel set, the combination of the colors of each subpixel set is set so that the sum of the first-class subpixel set is smaller than in a case where it is assumed that the colors of the two subpixels of each subpixel set are identical.

### BACKGROUND

### 1. Field

The present disclosure relates to a liquid crystal projector.

### 2. Description of the Related Art

Liquid crystal projectors are classified into a three-plate type of liquid crystal projector and a single-plate type of liquid crystal projector according to the number of liquid crystal panels used. A single-plate type of liquid crystal projector is superior to a three-plate type of liquid crystal projector in terms of reduction in size, reduction in weight, and reduction in price. A single-plate type of liquid crystal projector is disclosed, for example, in Japanese Unexamined Patent Application Publication No. 2008-268639.

The liquid crystal projector disclosed in Japanese Unexamined Patent Application Publication No. 2008-268639 includes a light source, a polarizing beam splitter, a reflective liquid crystal panel, and a projector lens. In the liquid crystal projector of Japanese Unexamined Patent Application Publication No. 2008-268639, light emitted from the light source is separated by the polarizing beam splitter into S-polarized light and P-polarized light. The reflective liquid crystal panel has a color filter and is disposed to receive the P-polarized light transmitted through the polarizing beam splitter. A projected image is formed by reflected light from the reflective liquid crystal panel, i.e. light modulated by the reflective liquid crystal panel, being projected by the projector lens onto a screen.

Further, Japanese Unexamined Patent Application Publication No. 2007-25598 discloses a liquid crystal projector including a first reflective liquid crystal panel for receiving P-polarized light transmitted through a polarizing beam splitter and modulating the P-polarized light and a second reflective liquid crystal panel for receiving S-polarized light transmitted through the polarizing beam splitter and modulating the S-polarized light. The first reflective liquid crystal panel and the second reflective liquid crystal panel both have color filters. The liquid crystal projector of Japanese Unexamined Patent Application Publication No. 2007-25598 can achieve a high-luminance color display by including the first reflective liquid crystal panel, which corresponds to the P-polarized light, and the second reflective liquid crystal panel, which corresponds to the S-polarized light.

The inventors of the present disclosure found that lines of light and dark (uneven streaks) are undesirably visually recognized in a projected image projected by a liquid crystal projector including a polarizing beam splitter and a reflective liquid crystal panel having a color filter, such as liquid crystal projectors of Japanese Unexamined Patent Application Publication No. 2008-268639 and Japanese Unexamined Patent Application Publication No. 2007-25598.

It is desirable to inhibit lines of light and dark from being visually recognized in a projected image projected by a liquid crystal projector including a polarizing beam splitter and a reflective liquid crystal panel having a color filter.

### SUMMARY

According to an aspect of the disclosure, there is provided a liquid crystal projector including a light source that emits white light, a polarizing beam splitter that separates the white light emitted from the light source into S-polarized light and P-polarized light, a first reflective liquid crystal panel disposed to receive the S-polarized light, and a second reflective liquid crystal panel disposed to receive the P-polarized light. The first reflective liquid crystal panel and the second reflective liquid crystal panel each have a color filter layer and a plurality of pixels. Each of the plurality of pixels includes a plurality of subpixels of colors that are different from one another. A projected image is formed by projection of reflected light from the first reflective liquid crystal panel and reflected light from the second reflective liquid crystal panel. When each subpixel of the first reflective liquid crystal panel is referred to as a first subpixel, each subpixel of the second reflective liquid crystal panel is referred to as a second subpixel, and a combination of the first subpixel and the second subpixel that correspond to an identical subpixel in the projected image is referred to as a subpixel set, a plurality of types of subpixel sets that are different in combination of the colors of the first subpixel and the second subpixel from each other are present. When, of the plurality of types of subpixel sets, a subpixel set in which a sum of luminance index values of the colors of the first subpixel and the second subpixel is largest is referred to as a first-class subpixel set, the combination of the colors of the first subpixel and the second subpixel of each of the plurality of types of subpixel sets is set so that the sum of the first-class subpixel set is smaller than in a case where it is assumed that the colors of the first subpixel and the second subpixel of each of the plurality of types of subpixel sets are identical.

### BRIEF DESCRIPTION OF THE DRAWINGS

FIG. 1 is a diagram schematically showing a liquid crystal projector according to an embodiment of the present disclosure;

FIG. 2A is a cross-sectional view schematically showing a first reflective liquid crystal panel of the liquid crystal projector;

FIG. 2B is a cross-sectional view schematically showing a second reflective liquid crystal panel of the liquid crystal projector;

FIG. 3A is a diagram for explaining the principle of a display using S-polarized light and shows a black display state;

FIG. 3B is a diagram for explaining the principle of a display using the S-polarized light and shows a white display state;

FIG. 4A is a diagram for explaining the principle of a display using P-polarized light and shows a black display state;

FIG. 4B is a diagram for explaining the principle of a display using the P-polarized light and shows a white display state;

FIG. 5 is a diagram juxtaposing an arrangement of subpixels in the first liquid crystal panel and an arrangement of subpixels in the second liquid crystal panel;

FIG. 6 is a diagram juxtaposing an arrangement of first subpixels and an arrangement of second subpixels in a projected image;

FIG. 7 is a diagram schematically showing a liquid crystal projector of a comparative example;

FIG. 8 is a diagram juxtaposing an arrangement of subpixels in a first liquid crystal panel of the liquid crystal projector of the comparative example and an arrangement of subpixels in a second liquid crystal panel of the liquid crystal projector of the comparative example;

FIG. 9 is a diagram juxtaposing an arrangement of first subpixels and an arrangement of second subpixels in a projected image projected by the liquid crystal projector of the comparative example;

FIG. 10 is a diagram juxtaposing an arrangement of first subpixels and an arrangement of second subpixels in a projected image and showing a magnitude relationship among the Y values of red, green, and blue and variations of light and dark in a case where a white display by the first liquid crystal panel is projected and a case where a white display by the second liquid crystal panel is projected; and

FIG. 11 is a diagram showing other examples of an arrangement of subpixels in the first liquid crystal panel and an arrangement of subpixels in the second liquid crystal panel.

### DESCRIPTION OF THE EMBODIMENTS

An embodiment of the present disclosure is described below with reference to the drawings. The present disclosure is not limited to the embodiment described below.

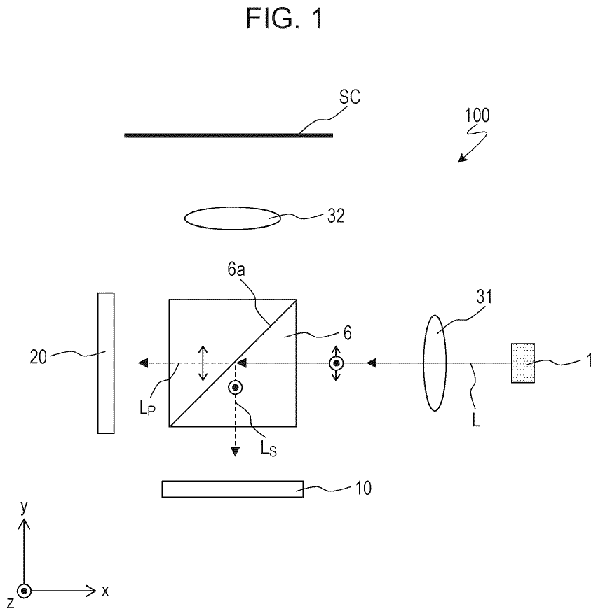

First, a liquid crystal projector 100 according to the embodiment of the present disclosure is described with reference to FIG. 1. FIG. 1 is a diagram schematically showing the liquid crystal projector 100.

As shown in FIG. 1, the liquid crystal projector 100 includes a light source 1, a polarizing beam splitter 6, a first reflective liquid crystal panel 10, and a second reflective liquid crystal panel 20.

The light source 1 emits white light L. As the light source 1, various light sources that can emit the white light L can be used. The light source 1 can be, for example, a pseudo-white LED including an LED that emits blue light and a yellow phosphor that emits yellow light upon excitation by blue light. Alternatively, the light source 1 may include an LED that emits red light, an LED that emits green light, and an LED that emits blue light.

The polarizing beam splitter (hereinafter referred to as “PBS”) 6 separates the white light L emitted from the light source 1 into S-polarized light LS and P-polarized light LP. The S-polarized light LS of the white light L falling on the PBS 6 is a polarization component the direction of vibration of which is parallel to a z axis in the drawing, and is reflected off a polarization separation plane 6a of the PBS 6. On the other hand, the P-polarized light LP of the white light L falling on the PBS 6 is a polarization component the direction of vibration of which is orthogonal to the z axis (parallel to a y axis) in the drawing, and passes through the polarization separation plane 6a. It is preferable that the PBS 6 be able to separate the S-polarized light LS and the P-polarized light LP from each other in as wide a wavelength range as possible of a visible light region. The PBS 6 can be, for example, of a cube type, a plate type, a wire grid type, or other types.

The first reflective liquid crystal panel (hereinafter referred to as “first liquid crystal panel”) 10 is disposed to receive the S-polarized light LS emitted from the PBS 6. The first liquid crystal panel 10 can modulate the S-polarized light LS in accordance with an image signal.

The second reflective liquid crystal panel (hereinafter referred to as “second liquid crystal panel”) 20 is disposed to receive the P-polarized light LP emitted from the PBS 6. The second liquid crystal panel 20 can modulate the P-polarized light LP in accordance with an image signal.

The liquid crystal projector 100 further includes an illuminating optical system placed between the light source 1 and the PBS 6 and a projector optical system placed between the PBS 6 and a screen SC.

The illuminating optical system guides to the PBS 6 the white light L emitted from the light source 1. Although FIG. 1 illustrates, as the illuminating optical system, one convex lens 31 that magnifies the white light L emitted from the light source 1, the illuminating optical system is not limited to this example. The illuminating optical system can include at least one convex lens and/or at least one concave lens. Of course, the illuminating optical system may include an optical member other than a lens.

The projector optical system magnifies and projects, onto the screen SC, reflected light from the first liquid crystal panel 10 and reflected light from the second liquid crystal panel 20. Although FIG. 1 illustrates one convex lens 32 as the projector optical system, the projector optical system is not limited to this example. The projector optical system can include at least one convex lens and/or at least one concave lens. Of course, the projector optical system may include an optical member other than a lens.

In the liquid crystal projector 100, a projected image is formed on the screen SC by projection of the reflected light from the first liquid crystal panel 10 and the reflected light from the second liquid crystal panel 20. It can also be said that the projected image formed on the screen SC is a combination of a projected image of the reflected light from the first liquid crystal panel 10 and a projected image of the reflected light from the second liquid crystal panel 20.

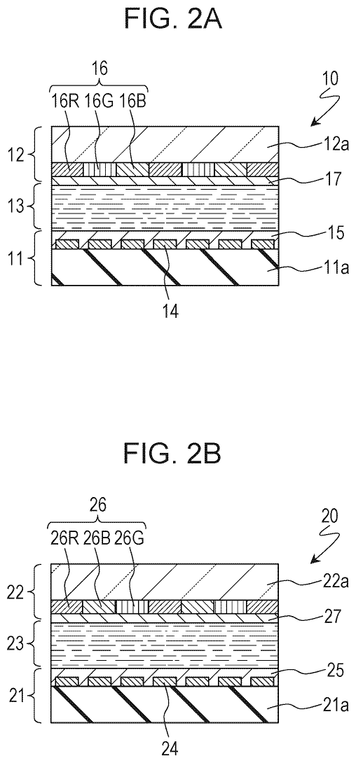

FIGS. 2A and 2B are cross-sectional views schematically showing the first liquid crystal panel 10 and the second liquid crystal panel 20, respectively.

As shown in FIG. 2A, the first liquid crystal panel 10 includes an active matrix substrate 11, a counter substrate 12 facing the active matrix substrate 11, and a liquid crystal layer 13 provided between the active matrix substrate 11 and the counter substrate 12. Further, the first liquid crystal panel 10 includes a plurality of pixels arrayed in a matrix. Each of the plurality of pixels includes a plurality of subpixels of colors that are different from one another. In this example, each pixel includes a red-colored subpixel (hereinafter referred to as “red subpixel), a green-colored subpixel (hereinafter referred to as ”green subpixel), and a blue-colored subpixel (hereinafter referred to as “blue subpixel).

The active matrix substrate 11 includes pixel electrodes 14 provided separately in each of the subpixels and a first alignment film 15 provided in contact with the liquid crystal layer 13. Although not illustrated here, the active matrix substrate 11 further includes thin-film transistors (TFTs) electrically connected to the pixel electrodes 14 and wires through which to supply signals to the TFTs. The pixel electrodes 14 or other components mentioned above are supported by an insulative substrate 11a. The pixel electrodes 14 may be formed from a high-reflectance metallic material and function as a reflective layer. Alternatively, the pixel electrodes 14 may be formed from a transparent conductive material, and a reflecting layer may be provided separately from the pixel electrodes 14.

The counter substrate 12 includes a color filter layer 16 and a second alignment film 17 provided in contact with the liquid crystal layer 13. The color filter layer 16 includes red color filters 16R, green color filters 16G, and blue color filters 16B. The red color filters 16R, the green color filters 16G, and the blue color filters 16B are arrayed, for example, in stripes. The color filter layer 16 or other components mentioned above are supported by a transparent insulative substrate 12a.

A display mode of the first liquid crystal panel 10 can be, for example, a horizontal alignment mode or a vertical alignment mode. In the horizontal alignment mode, liquid crystal molecules contained in the liquid crystal layer 13 are homogeneously aligned (i.e. aligned substantially parallel to board surfaces of the active matrix substrate 11 and the counter substrate 12) in the absence of the application of a voltage. In the vertical alignment mode, the liquid crystal molecules contained in the liquid crystal layer 13 are aligned substantially perpendicular to the board surfaces of the active matrix substrate 11 and the counter substrate 12 in the absence of the application of a voltage.

Although not illustrated here, the first liquid crystal panel 10 further includes a common electrode for applying a voltage to the liquid crystal layer 13 together with the pixel electrodes 14. In a display mode using a longitudinal electric field, the common electrode is provided beside the counter substrate 12. In a display mode using a transverse electric field, the common electrode is provided beside the active matrix substrate 11.

As shown in FIG. 2B, the second liquid crystal panel 20 includes an active matrix substrate 21, a counter substrate 22 facing the active matrix substrate 21, and a liquid crystal layer 23 provided between the active matrix substrate 21 and the counter substrate 22. Further, the second liquid crystal panel 20 includes a plurality of pixels arrayed in a matrix. Each of the plurality of pixels includes a plurality of subpixels of colors that are different from one another. In this example, each pixel includes a red subpixel, a green subpixel, and a blue subpixel.

The active matrix substrate 21 includes pixel electrodes 24 provided separately in each of the subpixels and a first alignment film 25 provided in contact with the liquid crystal layer 23. Although not illustrated here, the active matrix substrate 21 further includes TFTs electrically connected to the pixel electrodes 24 and wires through which to supply signals to the TFTs. The pixel electrodes 24 or other components mentioned above are supported by an insulative substrate 21a. The pixel electrodes 24 may be formed from a high-reflectance metallic material and function as a reflective layer. Alternatively, the pixel electrodes 24 may be formed from a transparent conductive material, and a reflecting layer may be provided separately from the pixel electrodes 24.

The counter substrate 22 includes a color filter layer 26 and a second alignment film 27 provided in contact with the liquid crystal layer 23. The color filter layer 26 includes red color filters 26R, green color filters 26G, and blue color filters 26B. The red color filters 26R, the green color filters 26G, and the blue color filters 26B are arrayed, for example, in stripes. The color filter layer 26 or other components mentioned above are supported by a transparent insulative substrate 22a.

A display mode of the second liquid crystal panel 20 can be, for example, a horizontal alignment mode or a vertical alignment mode. In the horizontal alignment mode, liquid crystal molecules contained in the liquid crystal layer 23 are homogeneously aligned (i.e. aligned substantially parallel to board surfaces of the active matrix substrate 21 and the counter substrate 22) in the absence of the application of a voltage. In the vertical alignment mode, the liquid crystal molecules contained in the liquid crystal layer 23 are aligned substantially perpendicular to the board surfaces of the active matrix substrate 21 and the counter substrate 22 in the absence of the application of a voltage.

Although not illustrated here, the second liquid crystal panel 20 further includes a common electrode for applying a voltage to the liquid crystal layer 23 together with the pixel electrodes 24. In a display mode using a longitudinal electric field, the common electrode is provided beside the counter substrate 22. In a display mode using a transverse electric field, the common electrode is provided beside the active matrix substrate 21.

The first liquid crystal panel 10 and the second liquid crystal panel 20 are positionally adjusted so that the projected images of the reflected light from the first liquid crystal panel 10 and the second liquid crystal panel 20 match on the screen SC.

The following explains the principle of display of the liquid crystal projector 100.

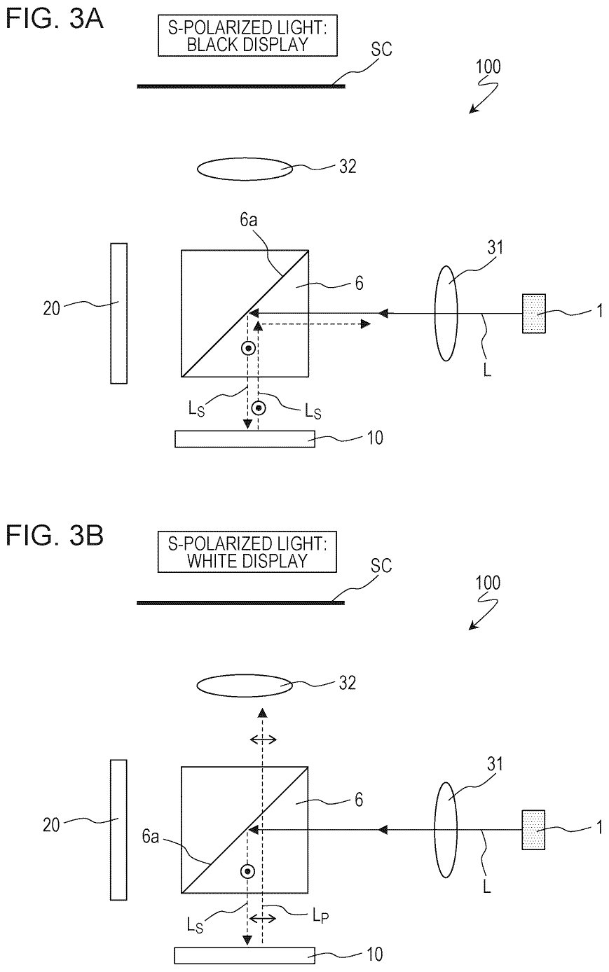

First, a display using the S-polarized light LS is described with reference to FIGS. 3A and 3B. FIGS. 3A and 3B are diagrams showing a black display state and a white display state, respectively.

As already explained, the S-polarized light LS of the white light L emitted from the light source 1 is reflected off the polarization separation plane 6a of the PBS 6 and travels toward the first liquid crystal panel 10. In a case where a black display is performed, no voltage is applied to the liquid crystal layer 13 of the first liquid crystal panel 10, and the direction of alignment of the liquid crystal molecules contained in the liquid crystal layer 13 are substantially parallel or substantially orthogonal to the direction of vibration of the S-polarized light LS. Therefore, as shown in FIG. 3A, the S-polarized light LS falling on the first liquid crystal panel 10 is reflected as it is and travels toward the PBS 6. The S-polarized light LS, which is reflected light from the first liquid crystal panel 10, is reflected off the polarization separation plane 6a of the PBS 6 and therefore is not projected onto the screen SC, so that a black display results.

On the other hand, in a case where a white display is performed, a predetermined voltage is applied to the liquid crystal layer 13 of the first liquid crystal panel 10, and the direction of alignment of the liquid crystal molecules forms a predetermined angle (e.g. 45 degrees) with respect to the direction of vibration of the S-polarized light LS. The phase difference Δn⋅d of the liquid crystal layer 13 in this state is set to substantially λ/4; therefore, as shown in FIG. 3B, the S-polarized light LS falling on the first liquid crystal panel 10 is converted into the P-polarized light LP, which then travels toward the PBS 6. The P-polarized light LP, which is reflected light from the first liquid crystal panel 10, passes through the polarization separation plane 6a of the PBS 6 and therefore is projected onto the screen SC, so that a white display results.

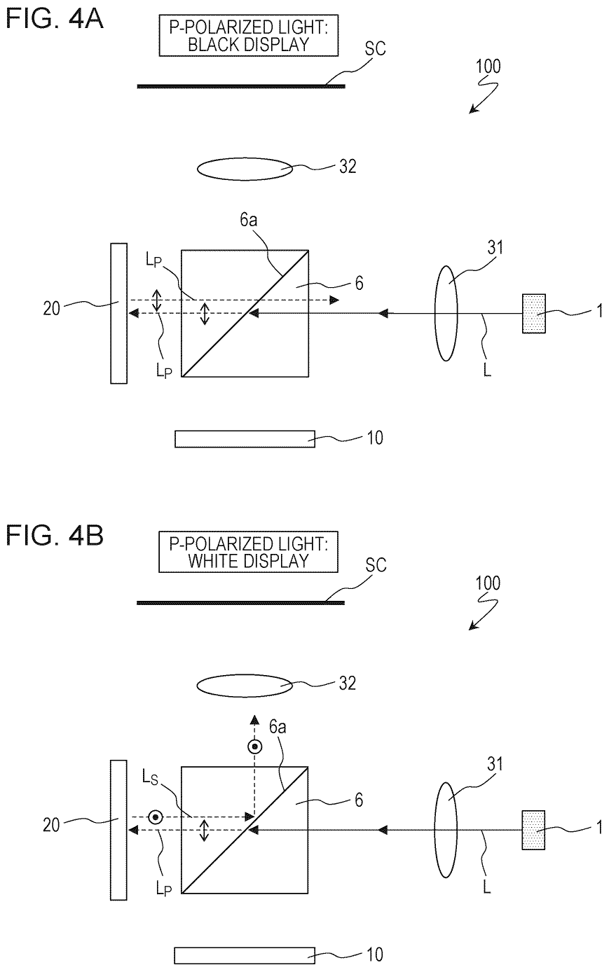

Next, a display using the P-polarized light LP is described with reference to FIGS. 4A and 4B. FIGS. 4A and 4B are diagrams showing a black display state and a white display state, respectively.

As already explained, the P-polarized light LP of the white light L emitted from the light source 1 passes through the polarization separation plane 6a of the PBS 6 and travels toward the second liquid crystal panel 20. In a case where a black display is performed, no voltage is applied to the liquid crystal layer 23 of the second liquid crystal panel 20, and the direction of alignment of the liquid crystal molecules contained in the liquid crystal layer 23 are substantially parallel or substantially orthogonal to the direction of vibration of the P-polarized light LP. Therefore, as shown in FIG. 4A, the P-polarized light LP falling on the second liquid crystal panel 20 is reflected as it is and travels toward the PBS 6. The P-polarized light LP, which is reflected light from the second liquid crystal panel 20, passes through the polarization separation plane 6a of the PBS 6 and therefore is not projected onto the screen SC, so that a black display results.

On the other hand, in a case where a white display is performed, a predetermined voltage is applied to the liquid crystal layer 23 of the second liquid crystal panel 20, and the direction of alignment of the liquid crystal molecules forms a predetermined angle (e.g. 45 degrees) with respect to the direction of vibration of the P-polarized light LP. The phase difference Δn⋅d of the liquid crystal layer 23 in this state is set to substantially λ/4; therefore, as shown in FIG. 4B, the P-polarized light LP falling on the second liquid crystal panel 20 is converted into the S-polarized light LS, which then travels toward the PBS 6. The S-polarized light LS, which is reflected light from the second liquid crystal panel 20, is reflected off the polarization separation plane 6a of the PBS 6 and therefore is projected onto the screen SC, so that a white display results.

The following describes arrangements of subpixels in the liquid crystal projector 100 of the present embodiment.

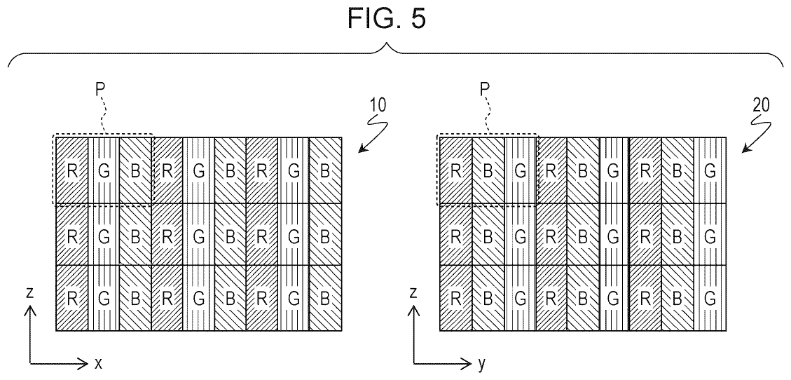

FIG. 5 is a diagram juxtaposing an arrangement of subpixels in the first liquid crystal panel 10 and an arrangement of subpixels in the second liquid crystal panel 20. As shown in FIG. 5, the first liquid crystal panel 10 and the second liquid crystal panel 20 have pixels P each composed of a red subpixel R, a green subpixel G, and a blue subpixel B.

In each of the pixels P of the first liquid crystal panel 10, the red subpixel R, the green subpixel G, and the blue subpixel B are arranged in this order from a side corresponding to a first end of the projected image toward a side corresponding to a second end of the projected image (along a +x-axis direction in the drawing). On the other hand, in each of the pixels P of the second liquid crystal panel 20, the red subpixel R, the blue subpixel B, and the green subpixel G are arranged in this order from a side corresponding to the first end of the projected image toward a side corresponding to the second end of the projected image (along a +y-axis direction in the drawing). That is, the arrangement of subpixels of the second liquid crystal panel 20 can be said to be an arrangement of subpixels of the first liquid crystal panel 10 in which the green subpixel G and the blue subpixel B swap positions with each other.

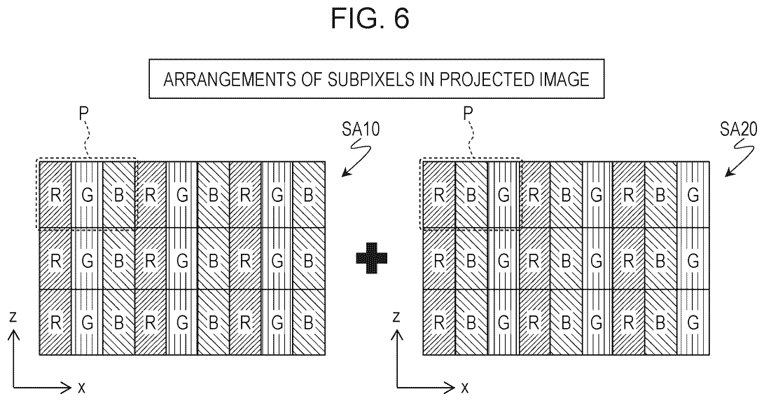

For convenience of explanation, each subpixel of the first liquid crystal panel 10 is referred to as “first subpixel”, and each subpixel of the second liquid crystal panel 20 is referred to as “second subpixel”. FIG. 6 is a diagram juxtaposing an arrangement SA10 of first subpixels and an arrangement SA20 of second subpixels in the projected image.

As can be understood from FIG. 6, each pixel in the projected image (i.e. a combination of a projected image of the first liquid crystal panel 10 and a projected image of the second liquid crystal panel 20) is composed of [1] a subpixel defined by a red subpixel R of the first liquid crystal panel 10 and a red subpixel R of the second liquid crystal panel 20, [2] a subpixel defined by a green subpixel G of the first liquid crystal panel 10 and a blue subpixel B of the second liquid crystal panel 20, and [3] a subpixel defined by a blue subpixel B of the first liquid crystal panel 10 and a green subpixel G of the second liquid crystal panel 20.

When a combination of a first subpixel and a second subpixel corresponding to an identical subpixel in the projected image is referred to as “subpixel set”, a plurality of types of subpixel sets that are different in combination of the colors of the first subpixel and the second subpixel from each other are present in the liquid crystal projector 100. Specifically, a subpixel set that is a combination of red subpixels R (i.e. the subpixel set defining the subpixels of [1] above in the projected image) and subpixel sets that are combinations of a green subpixel G and a blue subpixel B (i.e. the subpixel set defining the subpixels of [2] above and the subpixel set defining the subpixels of [3] above in the projected image) are present.

Of the plurality of types of subpixel sets, a subpixel set in which the sum of the “luminance index values” of the colors of the first subpixel and the second subpixel is largest is herein referred to as “first-class subpixel set”, and a subpixel set in which the sum of the “luminance index values” of the colors of the first subpixel and the second subpixel is smallest is herein referred to as “second-class subpixel set”. The term “luminance index value” refers to, but is not limited to, a value that represents the luminance (brightness) of a color displayed by a subpixel, e.g. a Y value in an XYZ color system. Further, a luminance index value may be an absolute value obtained from an optical measurement or may be a relative value to a certain reference value. The sum of luminance index values is sometimes referred to as “luminance sum”.

In general, in a case where each of the pixels P is composed of a red subpixel R, a green subpixel G, and a blue subpixel B, the luminance index value of the green subpixel G is largest, and the luminance index value of the blue subpixel is smallest (that is, the luminance index value of the red subpixel R lies between the luminance index value of the green subpixel G and the luminance index value of the blue subpixel). In a case where the luminance index values are Y values as mentioned above, the Y value of red displayed by the red subpixel R is approximately 0.25, the Y value of green displayed by the green subpixel G approximately 0.63, and the Y value of blue displayed by the blue subpixel B approximately 0.12, with the Y value of white displayed by the pixel P being 1. Therefore, in the liquid crystal projector 100 of the present embodiment, the “first-class subpixel set” is a subpixel set that is a combination of a green subpixel G and a blue subpixel B, and the “second-class subpixel set” is a subpixel set that is a combination of red subpixels R.

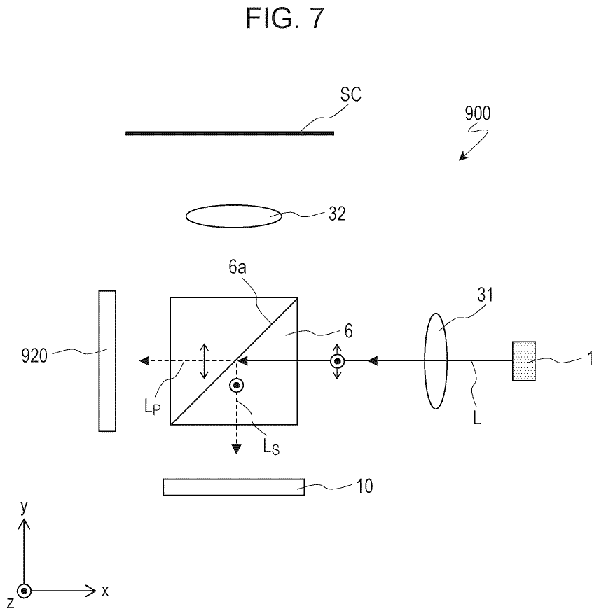

By having the aforementioned configuration, the liquid crystal projector 100 of the present embodiment can inhibit lines of light and dark from being visually recognized in the projected image. A reason for this is explained below in comparison with a liquid crystal projector 900 of a comparative example shown in FIG. 7.

FIG. 7 is a diagram showing the liquid crystal projector 900 of the comparative example. The liquid crystal projector 900 of the comparative example has substantially the same configuration as the liquid crystal projector 100 of the present embodiment. Note, however, that the liquid crystal projector 900 of the comparative example includes a second liquid crystal panel 920 having a configuration that is different from that of the second liquid crystal panel 20 of the liquid crystal projector 100 of the present embodiment.

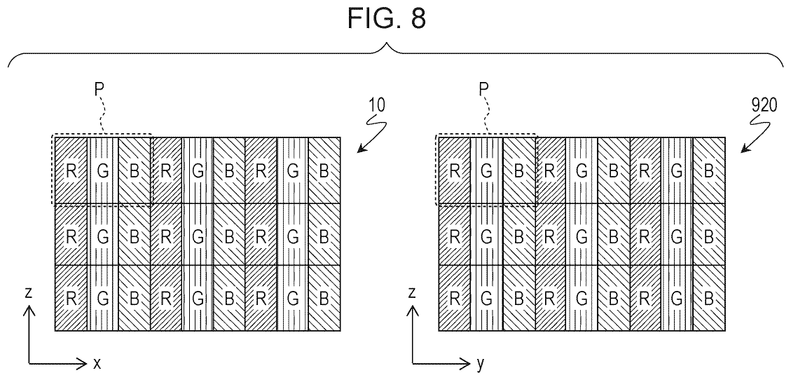

Arrangements of subpixels in the liquid crystal projector 900 of the comparative example are described with reference to FIG. 8. FIG. 8 is a diagram juxtaposing an arrangement of subpixels in the first liquid crystal panel 10 of the liquid crystal projector 900 of the comparative example and an arrangement of subpixels in the second liquid crystal panel 920 of the liquid crystal projector 900 of the comparative example.

As shown in FIG. 8, in each of the pixels P of the first liquid crystal panel 10, the red subpixel R, the green subpixel G, and the blue subpixel B are arranged in this order from a side corresponding to a first end of the projected image toward a side corresponding to a second end of the projected image (along a +x-axis direction in the drawing). Also, in each of the pixels P of the second liquid crystal panel 920, the red subpixel R, the green subpixel G, and the blue subpixel B are arranged in this order from a side corresponding to the first end of the projected image toward a side corresponding to the second end of the projected image (along a +y-axis direction in the drawing). That is, the arrangement of subpixels in the second liquid crystal panel 920 is identical to the arrangement of subpixels in the first liquid crystal panel 10.

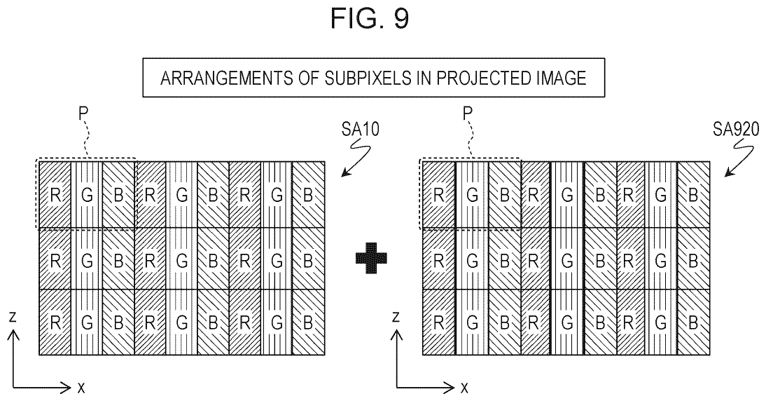

FIG. 9 is a diagram juxtaposing an arrangement SA10 of first subpixels and an arrangement SA920 of second subpixels in a projected image projected by the liquid crystal projector 900 of the comparative example.

As can be understood from FIG. 9, each pixel in the projected image (i.e. a combination of a projected image of the first liquid crystal panel 10 and a projected image of the second liquid crystal panel 920) is composed of [4] a subpixel defined by a red subpixel R of the first liquid crystal panel 10 and a red subpixel R of the second liquid crystal panel 920, [5] a subpixel defined by a green subpixel G of the first liquid crystal panel 10 and a green subpixel G of the second liquid crystal panel 920, and a subpixel defined by a blue subpixel B of the first liquid crystal panel 10 and a blue subpixel B of the second liquid crystal panel 920.

Also in the liquid crystal projector 900 of the comparative example, a plurality of types of subpixel sets that are different in combination of the colors of the first subpixel and the second subpixel from each other are present. Specifically, a subpixel set that is a combination of red subpixels R (i.e. the subpixel set defining the subpixels of [4] above in the projected image), a subpixel set that is a combination of green subpixels G (i.e. the subpixel set defining the subpixels of [5] above in the projected image), and a subpixel set that is a combination of blue subpixels B (i.e. the subpixel set defining the subpixels of [6] above in the projected image) are present.

In the liquid crystal projector 900 of the comparative example, the “first-class subpixel set” is a subpixel set that is a combination of green subpixels G, and the “second-class subpixel set” is a subpixel set that is a combination of blue subpixels B.

In the liquid crystal projector 900 of the comparative example thus configured, there is concern that lines of light and shape (uneven streaks) may be visually recognized in the projected image. This is attributed to the fact that the luminance sum of the first-class subpixel set is large and the fact that the difference between the luminance sum of the first-class subpixel set and the luminance sum of the second-class subpixel set is large. While a direct-view-type liquid crystal display device has its pixel size set so that uneven streaks are not visually recognized by humans, the liquid crystal projector, which magnifies and projects an image displayed on the liquid crystal panel, undesirably has such a pixel size that humans visually recognize uneven streaks.

On the other hand, the liquid crystal projector 100 of the present embodiment is smaller in luminance sum of the first-class subpixel set than the liquid crystal projector 900 of the comparative example. In terms of the Y values illustrated, the luminance sum of the first-class subpixel set in the liquid crystal projector 900 of the comparative example is approximately 1.26, and the luminance sum of the first-class subpixel set in the liquid crystal projector 100 of the present embodiment is approximately 0.75. This inhibits lines of light and dark from being visually recognized in the projected image. Further, the liquid crystal projector 100 of the present embodiment is smaller in difference between the luminance sum of the first-class subpixel set and the luminance sum of the second-class subpixel set than the liquid crystal projector 900 of the comparative example. In terms of the Y values illustrated, the difference between the luminance sum of the first-class subpixel set and the luminance sum of the second-class subpixel set in the liquid crystal projector 900 of the comparative example is approximately 1.02, and the difference between the luminance sum of the first-class subpixel set and the luminance sum of the second-class subpixel set in the liquid crystal projector 100 of the present embodiment is approximately 0.25. This also inhibits lines of light and dark from being visually recognized in the projected image.

Thus, in the liquid crystal projector 100 of the present embodiment, the combination of the colors of the first subpixel and the second subpixel of each of the plurality of types of subpixel sets is set so that the luminance sum of the first-class subpixel set is smaller than in a case where it is assumed that the colors of the first subpixel and the second subpixel of each of the plurality of types of subpixel sets are identical (this case being equivalent to the configuration of the liquid crystal projector 900 of the comparative example). Further, in the liquid crystal projector 100 of the present embodiment, the combination of the colors of the first subpixel and the second subpixel of each of the plurality of types of subpixel sets is set so that the difference between the luminance sum of the first-class subpixel set and the luminance sum of the second-class subpixel set is smaller than in a case where it is assumed that the colors of the first subpixel and the second subpixel of each of the plurality of types of subpixel sets are identical (this case being equivalent to the configuration of the liquid crystal projector 900 of the comparative example).

The following explains results of actually prototyping the liquid crystal projector 900 of the comparative example and the liquid crystal projector 100 of the present embodiment (the liquid crystal projector 100 thus prototyped being hereinafter referred to as “example”) and verifying whether lines of light and dark (uneven streaks) are visually recognized.

In prototyping, the light source 1 used was a Rohm's LED (commercially available as “MSL0402RGBU”), and the PBS 6 used was an Edmund's polarizing beam splitter (commercially available as “Broadband Polarizing Cube B/S VIS”). Further, the liquid crystal layer 13 of the first liquid crystal panel 10 and the liquid crystal layer 23 of the second liquid crystal panel 20 (920) were formed using a negative liquid crystal material, and the direction of alignment in the absence of the application of a voltage was set to be substantially parallel to the direction of vibration of the S-polarized light LS or the P-polarized light LP. Furthermore, the cell thickness was set so that the phase differences Δn⋅d of the liquid crystal layers in the presence of the application of a white display voltage were 140 nm.

The in-plane uniformity of a projected image formed on the screen SC of the comparative example and the in-plane uniformity of a projected image formed on the screen SC of the example were visually compared and evaluated. As a result of that, while uneven streaks were visually recognized in the comparative example, no uneven streaks were visually recognized in the example, which was therefore higher in in-plane uniformity than the comparative example. Thus, it was confirmed, in the example, that lines of light and dark in the projected image are inhibited from being visually recognized.

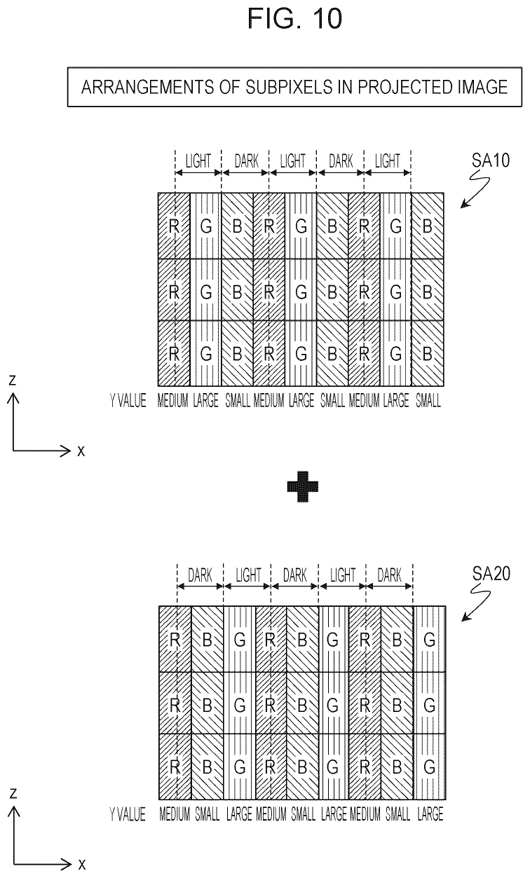

FIG. 10, like FIG. 6, is a diagram juxtaposing an arrangement SA10 of first subpixels and an arrangement SA20 of second subpixels in a projected image. FIG. 10 also shows a magnitude relationship among the Y values of red, green, and blue and variations of light and dark in a case where a white display by the first liquid crystal panel 10 is projected and a case where a white display by the second liquid crystal panel 20 is projected.

As can be seen from FIG. 10, lines of light and dark in an image obtained by projecting the display of the first liquid crystal panel 10 and lines of light and dark in an image obtained by projecting the display of the second liquid crystal panel 20 are each other's reversals, so that a combination (final projected image) of the two images is high in in-plane uniformity.

Thus, the liquid crystal projector 100 of the present embodiment inhibits lines of light and dark from being visually recognized in the projected image.

The arrangement of subpixels in each pixel P is not limited to the example shown in FIG. 5. In the example shown in FIG. 5, in each pixel P of the first liquid crystal panel 10, the red subpixel R, the green subpixel G, and the blue subpixel B are arranged in this order from a side corresponding to a first end of the projected image toward a side corresponding to a second end of the projected image, and in each pixel P of the second liquid crystal panel 20, the red subpixel R, the blue subpixel B, and the green subpixel G are arranged in this order from a side corresponding to the first end of the projected image toward a side corresponding to the second end of the projected image.

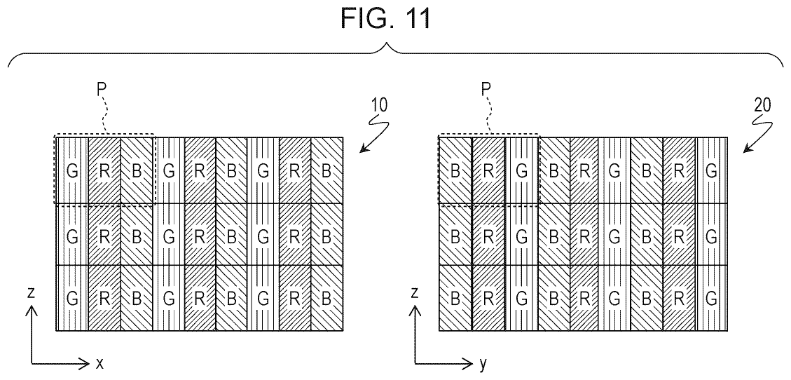

On the other hand, for example, arrangements of subpixels shown in FIG. 11 may be adopted. In the example shown in FIG. 11, in each pixel P of the first liquid crystal panel 10, the green subpixel G, the red subpixel R, and the blue subpixel B are arranged in this order from a side corresponding to a first end of the projected image toward a side corresponding to a second end of the projected image, and in each pixel P of the second liquid crystal panel 20, the blue subpixel B, the red subpixel R, and the green subpixel G are arranged in this order from a side corresponding to the first end of the projected image toward a side corresponding to the second end of the projected image. Even in a case where the arrangements of subpixels shown in FIG. 11 are adopted, effects that are similar to those brought about in a case where the arrangements of subpixels shown in FIG. 5 are adopted are brought about.

Further, although the foregoing description has illustrated an example in which each pixel P is composed of three subpixels, namely a red subpixel R, a green subpixel G, and a blue subpixel B, the number of subpixels that constitute a pixel P and the combination of colors are not limited to this example.

The first-class subpixel set can be a combination of a subpixel of a first color that is largest in luminance index value of the plurality of subpixels and a subpixel of a second color that is smallest in luminance index value of the plurality of subpixels. The second-class subpixel set can be a combination of subpixels of a third color that is different from the first color and the second color.

Further, the first-class subpixel set can be a combination of a subpixel of a color that is largest in Y value of the plurality of subpixels and a subpixel of a color that is smallest in Y value of the plurality of subpixels.

From the point of view of, for example, improvement in light use efficiency and improvement in color reproducibility, it is preferable that the light source 1 have peaks of emission spectra in wavelength regions corresponding to red, green, and blue.

From the point of view of reducing cost by omitting a phase difference plate, it is preferable that the display modes of the first liquid crystal panel 10 and the second liquid crystal panel 20 be a horizontal alignment mode. In the case of the horizontal alignment mode, it is possible to suitably adopt a configuration in which the direction of alignment of liquid crystal molecules homogeneously aligned in the absence of the application of a voltage is substantially parallel to the direction of vibration of the S-polarized light LS or the P-polarized light LP and in which the phase differences Δn⋅d of the liquid crystal layers 13 and 23 are substantially λ/4 in the presence of the application of a predetermined voltage (specifically, a white display voltage). The “phase difference Δn⋅d of substantially λ/4” here means that a λ/4 condition is substantially satisfied with respect to visible light with a wavelength of 550 nm (e.g. that Δn⋅d falls within a range of 137.5 ±10 nm).

An embodiment of the present disclosure makes it possible to inhibit lines of light and dark from being visually recognized in a projected image projected by a liquid crystal projector including a polarizing beam splitter and a reflective liquid crystal panel having a color filter.

This specification discloses liquid crystal projectors described in the following items.

### Item 1

A liquid crystal projector comprising:
a light source that emits white light;
a polarizing beam splitter that separates the white light emitted from the light source into S-polarized light and P-polarized light;
a first reflective liquid crystal panel disposed to receive the S-polarized light; and
a second reflective liquid crystal panel disposed to receive the P-polarized light,
wherein
the first reflective liquid crystal panel and the second reflective liquid crystal panel each have a color filter layer and a plurality of pixels,
each of the plurality of pixels includes a plurality of subpixels of colors that are different from one another,
a projected image is formed by projection of reflected light from the first reflective liquid crystal panel and reflected light from the second reflective liquid crystal panel,
when each subpixel of the first reflective liquid crystal panel is referred to as a first subpixel, each subpixel of the second reflective liquid crystal panel is referred to as a second subpixel, and a combination of the first subpixel and the second subpixel that correspond to an identical subpixel in the projected image is referred to as a subpixel set, a plurality of types of subpixel sets that are different in combination of the colors of the first subpixel and the second subpixel from each other are present,
when, of the plurality of types of subpixel sets, a subpixel set in which a sum of luminance index values of the colors of the first subpixel and the second subpixel is largest is referred to as a first-class subpixel set, the combination of the colors of the first subpixel and the second subpixel of each of the plurality of types of subpixel sets is set so that the sum of the first-class subpixel set is smaller than in a case where it is assumed that the colors of the first subpixel and the second subpixel of each of the plurality of types of subpixel sets are identical.

### Item 2

The liquid crystal projector according to Item 1, wherein when, of the plurality of types of subpixel sets, a subpixel set in which the sum is smallest is referred to as a second-class subpixel set, the combination of the colors of the first subpixel and the second subpixel of each of the plurality of types of subpixel sets is set so that a difference between the sum of the first-class subpixel set and the sum of the second-class subpixel set is smaller than in a case where it is assumed that the colors of the first subpixel and the second subpixel of each of the plurality of types of subpixel sets are identical.

### Item 3

The liquid crystal projector according to Item 1 or 2, wherein the first-class subpixel set is a combination of a subpixel of a first color that is largest in luminance index value of the plurality of subpixels and a subpixel of a second color that is smallest in luminance index value of the plurality of subpixels.

### Item 4

The liquid crystal projector according to Item 3, wherein
the plurality of subpixels includes a subpixel of the first color, a subpixel of the second color, and a subpixel of a third color, and
the second-class subpixel set is a combination of subpixels of the third color.

### Item 5

The liquid crystal projector according to any one of Items 1 to 4, wherein the first-class subpixel set is a combination of subpixels of colors that are largest and smallest in Y value in an XYZ color system of the plurality of subpixels.

### Item 6

The liquid crystal projector according to any one of Items 1 to 5, wherein
each of the plurality of pixels includes a red subpixel, a green subpixel, and a blue subpixel, and
the plurality of types of subpixel sets include a subpixel set that is a combination of the red subpixels and a subpixel set that is a combination of the green subpixel and the blue subpixel.

### Item 7

The liquid crystal projector according to Item 6, wherein in each pixel of the first reflective liquid crystal panel, the red subpixel, the green subpixel, and the blue subpixel are arranged in this order from a side corresponding to a first end of the projected image toward a side corresponding to a second end of the projected image, and in each pixel of the second reflective liquid crystal panel, the red subpixel, the blue subpixel, and the green subpixel are arranged in this order from a side corresponding to the first end of the projected image toward a side corresponding to the second end of the projected image, or
in each pixel of the first reflective liquid crystal panel, the green subpixel, the red subpixel, and the blue subpixel are arranged in this order from a side corresponding to a first end of the projected image toward a side corresponding to a second end of the projected image, and in each pixel of the second reflective liquid crystal panel, the blue subpixel, the red subpixel, and the green subpixel are arranged in this order from a side corresponding to the first end of the projected image toward a side corresponding to the second end of the projected image.

### Item 8

The liquid crystal projector according to any one of Items 1 to 7, further comprising a projector optical system for magnifying and projecting the reflected light from the first reflective liquid crystal panel and the reflected light from the second reflective liquid crystal panel.

### Item 9

The liquid crystal projector according to any one of Items 1 to 8, wherein the light source has peaks of emission spectra in wavelength regions corresponding to red, green, and blue.

### Item 10

The liquid crystal projector according to any one of Items 1 to 9, wherein
the first reflective liquid crystal panel and the second reflective liquid crystal panel each have a liquid crystal layer, the liquid crystal layer contains liquid crystal molecules homogenously aligned in absence of application of a voltage,
a direction of alignment of the liquid crystal molecules homogeneously aligned is substantially parallel to a direction of vibration of the S-polarized light or the P-polarized light, and
the liquid crystal layer has a phase difference Δn⋅d of substantially λ/4 in presence of application of a predetermined voltage.

The present disclosure contains subject matter related to that disclosed in Japanese Priority Patent Application JP 2025-060594 filed in the Japan Patent Office on Apr. 1, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal projector comprising:
a light source that emits white light;
a polarizing beam splitter that separates the white light emitted from the light source into S-polarized light and P-polarized light;
a first reflective liquid crystal panel disposed to receive the S-polarized light; and
a second reflective liquid crystal panel disposed to receive the P-polarized light,
wherein
the first reflective liquid crystal panel and the second reflective liquid crystal panel each have a color filter layer and a plurality of pixels,
each of the plurality of pixels includes a plurality of subpixels of colors that are different from one another,
a projected image is formed by projection of reflected light from the first reflective liquid crystal panel and reflected light from the second reflective liquid crystal panel,
when each subpixel of the first reflective liquid crystal panel is referred to as a first subpixel, each subpixel of the second reflective liquid crystal panel is referred to as a second subpixel, and a combination of the first subpixel and the second subpixel that correspond to an identical subpixel in the projected image is referred to as a subpixel set, a plurality of types of subpixel sets that are different in combination of the colors of the first subpixel and the second subpixel from each other are present,
when, of the plurality of types of subpixel sets, a subpixel set in which a sum of luminance index values of the colors of the first subpixel and the second subpixel is largest is referred to as a first-class subpixel set, the combination of the colors of the first subpixel and the second subpixel of each of the plurality of types of subpixel sets is set so that the sum of the first-class subpixel set is smaller than in a case where it is assumed that the colors of the first subpixel and the second subpixel of each of the plurality of types of subpixel sets are identical.

2. The liquid crystal projector according to claim 1, wherein when, of the plurality of types of subpixel sets, a subpixel set in which the sum is smallest is referred to as a second-class subpixel set, the combination of the colors of the first subpixel and the second subpixel of each of the plurality of types of subpixel sets is set so that a difference between the sum of the first-class subpixel set and the sum of the second-class subpixel set is smaller than in a case where it is assumed that the colors of the first subpixel and the second subpixel of each of the plurality of types of subpixel sets are identical.

3. The liquid crystal projector according to claim 1, wherein the first-class subpixel set is a combination of a subpixel of a first color that is largest in luminance index value of the plurality of subpixels and a subpixel of a second color that is smallest in luminance index value of the plurality of subpixels.

4. The liquid crystal projector according to claim 3, wherein
the plurality of subpixels includes a subpixel of the first color, a subpixel of the second color, and a subpixel of a third color, and
the second-class subpixel set is a combination of subpixels of the third color.

5. The liquid crystal projector according to claim 1, wherein the first-class subpixel set is a combination of subpixels of colors that are largest and smallest in Y value in an XYZ color system of the plurality of subpixels.

6. The liquid crystal projector according to claim 1, wherein
each of the plurality of pixels includes a red subpixel, a green subpixel, and a blue subpixel, and
the plurality of types of subpixel sets include a subpixel set that is a combination of the red subpixels and a subpixel set that is a combination of the green subpixel and the blue subpixel.

7. The liquid crystal projector according to claim 6, wherein
in each pixel of the first reflective liquid crystal panel, the red subpixel, the green subpixel, and the blue subpixel are arranged in this order from a side corresponding to a first end of the projected image toward a side corresponding to a second end of the projected image, and in each pixel of the second reflective liquid crystal panel, the red subpixel, the blue subpixel, and the green subpixel are arranged in this order from a side corresponding to the first end of the projected image toward a side corresponding to the second end of the projected image, or in each pixel of the first reflective liquid crystal panel, the green subpixel, the red subpixel, and the blue subpixel are arranged in this order from a side corresponding to a first end of the projected image toward a side corresponding to a second end of the projected image, and in each pixel of the second reflective liquid crystal panel, the blue subpixel, the red subpixel, and the green subpixel are arranged in this order from a side corresponding to the first end of the projected image toward a side corresponding to the second end of the projected image.

8. The liquid crystal projector according to claim 1, further comprising a projector optical system for magnifying and projecting the reflected light from the first reflective liquid crystal panel and the reflected light from the second reflective liquid crystal panel.

9. The liquid crystal projector according to claim 1, wherein the light source has peaks of emission spectra in wavelength regions corresponding to red, green, and blue.

10. The liquid crystal projector according to claim 1, wherein
the first reflective liquid crystal panel and the second reflective liquid crystal panel each have a liquid crystal layer,
the liquid crystal layer contains liquid crystal molecules homogenously aligned in absence of application of a voltage,
a direction of alignment of the liquid crystal molecules homogeneously aligned is substantially parallel to a direction of vibration of the S-polarized light or the P-polarized light, and
the liquid crystal layer has a phase difference Δn⋅d of substantially λ/4 in presence of application of a predetermined voltage.
